(19) United States
(12) Patent Application Publication
(10) Pub. No.: US 2022/0112941 A1
(43) Pub. Date: Apr. 14, 2022

(54) PULL-TYPE SHIFT TRANSMISSION SYSTEM AND FOOD PROCESSOR

(71) Applicant: Yan Kwong WONG, Kowloon (HK)

(72) Inventors: Yan Kwong WONG, Kowloon (HK); Hung Tai WONG, Kowloon (HK); Hiu Fung YEUNG, Kowloon (HK)

(21) Appl. No.: 17/419,147

(22) PCT Filed: Nov. 15, 2019
(86) PCT No.: PCT/IB2019/059812

§ 371 Date: Jun. 28, 2021

(30) Foreign Application Priority Data
Dec. 27, 2018 (HK) 18116666.9
Aug. 28, 2019 (CN) 201910799936.8

(51) Int. Cl. F16H 29/08; A47J 43/046; A47J 43/044; A47J 43/08; B02C 18/24

(52) U.S. Cl. CPC F16H 29/08; A47J 43/046; A47J 43/044; A47J 2043/04454; A47J 43/082; B02C 18/24; A47J 43/085

(57) ABSTRACT

The invention relates to a pull type transmission system, which comprises a pull mechanism. The pull mechanism at least comprises a coaxial column, the coaxial column is formed by connecting rotary discs with different diameters, and planes connecting the rotary discs with different diameters are connecting faces. The pull mechanism is provided with a rope tying position, the rope tying position is arranged on a side face of the pull mechanism, and the pull rope is connected to the pull mechanism through the rope tying position at one end and is wound around the rotary discs. The pull mechanism is connected to a resilience mechanism and is used for retracting the pull rope after the pull rope is pulled out. The invention provides a non-electric pull type transmission system. The corresponding rotating gears can be changed through simple up-down pulling actions without having to shut down and replace equipment or interrupt the pulling operation, making the use more convenient.

### TECHNICAL FIELD

The present invention relates to a transmission system, particularly to a non-electric pull type transmission system.

### BACKGROUND ART

An existing pull type transmission system is mainly composed of a single round block or a plurality of coaxial round blocks with different diameters that are pieced together, and can be used in a manual pull type food chopping processor. A common manual pull type food chopping processor has only a single output mode. When the transmission ratio needs to be changed, for example when the torque, acceleration and deceleration are changed, the pull type transmission system composed of a plurality of round blocks that are pieced together will adjust the gears through a shift lever to achieve gear shift.

The foregoing existing pull type transmission system has at least the following disadvantages:

The output transmission ratio cannot be adjusted conveniently at any time.

For example, in a food chopper, when larger and harder food is cut in the beginning, a larger force is required instead of a higher speed, but when some small food is cut, a higher speed is required.

Some existing food choppers cannot change the transmission ratio. Even if the transmission ratio is changeable in some equipment, it is necessary to stop the pulling and adjust the structure (such as the positions of the gears or the coaxial round blocks) before it can be used continuously and it is impossible to use continuous actions to process the food, causing inconvenience in use.

### SUMMARY OF THE INVENTION

The main technical problem that the present invention solves is to provide a pull type transmission system and a food processor convenient for switching rotating gears.

The present invention adopts the following technical means.

A pull type transmission system is provided, which comprises a pull mechanism, the pull mechanism at least comprises a coaxial column, the coaxial column is formed by connecting rotary discs with different diameters, and planes connecting the rotary discs with different diameters are connecting faces; the pull mechanism is provided with a rope tying position, the rope tying position is arranged on a side face of the pull mechanism, and the pull rope is connected to the pull mechanism through the rope tying position at one end and is wound around the rotary discs; and the pull mechanism is connected to a resilience mechanism providing a resilience force and is used for retracting the pull rope after the pull rope is pulled out.

The coaxial column is formed by connecting two rotary discs with different diameters. The diameter of the upper rotary discs is larger, and the diameter of the lower rotary discs is smaller.

The connecting faces extend outward and are provided with flange protruding outward.

The rope tying position is arranged on the flange.

The rope tying position is adjacent to the connecting faces and located above or below the connecting faces.

The rope tying position is a structure that runs through the rotary discs, and forms a through slot inside the rotary discs, one end of the pull rope is connected to one end of the slot, and the other end of the pull rope passes through the slot and sticks out of the rotary discs.

The rope tying position is a structure that runs through the rotary discs, and the pull rope extends outward from the rotary discs.

The resilience mechanism is a set of coil springs and arranged above or below the pull mechanism.

A food processor is provided, which comprising the foregoing pull type transmission system, the pull mechanism is connected to a transmission mechanism, and the transmission mechanism is connected to a food processing device that is operated in a rotating manner.

The food processor is further provided with a bottom cover, the center of the bottom cover is connected to a resilience mechanism, the bottom cover is connected to the pull mechanism, the pull mechanism is sheathed with an upper cover that covers the pull mechanism, the upper cover comprises a top surface at the top and a side wall on the side face, the bottom edge of the side wall is connected to the bottom cover, and the side wall of the upper cover is provided with a guide groove allowing the pull rope to pass through.

The guide groove is arranged at same level with the rope tying position, the guide groove is a longitudinal guide groove, and the length of the guide groove spans the rotary discs with different diameters; the outer end of the pull rope is connected to a handle, and the length of the handle is greater than the length of the longitudinal guide groove.

The transmission mechanism is a rotating shaft or a transmission shaft connected to a one-way gear, and the upper part of the transmission shaft passes through the top surface of the upper cover and is connected to the food processing device.

The transmission system is further provided with a guide structure, the guide structure comprises a limit component allowing the pull rope to pass through and limiting the pull rope, and a control module controlling the up and down movement of the limit component, the pull rope passes through the limit component and the position of the limit component is controlled by the control module, thereby controlling the position of the pull rope.

The control module comprises a button shaft, below the button shaft is a second shaft, the diameter of the second shaft is smaller than the diameter of the button shaft, a third shaft is provided at a certain distance below the second shaft, the third shaft and the second shaft have the same diameter, and the second shaft and the third shaft are sheathed with a spring; a platform is connected below the third shaft, and the lower end of the spring presses against the platform; the limit component is a laterally arranged perforated sheet body, one side of the perforated sheet body is connected to the button shaft, and the pull rope passes through a hole of the perforated sheet body.

The control module comprises a button shaft, the button shaft is coaxially sheathed with a conduit slot, a thin shaft is connected below the button shaft, the thin shaft is sheathed with a spring, the top of the spring presses against the bottom of the button shaft, and the bottom of the spring presses against a bottom platform on the inner side of the conduit slot; the limit component is a laterally arranged perforated sheet body, one side of the perforated sheet body is connected to the thin shaft, and the pull rope passes through a hole of the perforated sheet body.

The control module is a button structure of a ball pen, and comprises a button shaft, the button shaft is coaxially sheathed with a conduit slot with a serrated bottom, the button shaft is sheathed with a spring used for reset, and a movable column that moves up and down is connected below the button shaft through a spring; the guide structure is a laterally arranged perforated sheet body, one side of the perforated sheet body is connected to the movable column, and the pull rope passes through a hole of the perforated sheet body.

The control module comprises a knob shaft, above the knob shaft is a knob, a shaft body is connected below the knob, a first guide structure is provided outside the shaft body, the shaft body is sheathed with a conduit slot, the inner side of the conduit slot is provided with a second guide structure that matches the first guide structure, and by relying on the interaction between the first guide structure and the second guide structure, the knob shaft is rotated to drive the conduit slot to move up and down; the guide structure is a laterally arranged perforated sheet body, one side of the perforated sheet body is connected to the conduit slot, and the pull rope passes through a hole of the perforated sheet body. The first guide structure is a threaded or tapered convex bone or groove, and the second guide structure is a threaded or tapered groove or convex bone.

A food processor is provided, which comprises the foregoing pull type transmission system, the pull mechanism is connected to a transmission mechanism, and the transmission mechanism is connected to a food processing device that is operated in a rotating manner; the transmission mechanism is a rotating shaft or a transmission shaft connected to a one-way gear, the food processing device is connected below the transmission shaft, and above the transmission shaft is an outer cover, and the upper plane of the outer cover is provided with a through hole to expose the guide structure.

The present invention has the following beneficial effects. The present invention provides a brand-new non-electric pull type transmission system, which can be used as a core structure to make various kinds of food processors. The non-electric pull type transmission system has a simple structure. The corresponding rotating gear can be changed through simple up-down pulling actions without having to shut down and replace equipment or interrupt the pulling operation, making the use more convenient.

### BRIEF DESCRIPTION OF THE DRAWINGS

FIG. 1a is a schematic view of a pull mechanism according to the present invention, with a pull rope wound around a rotary disc with a smaller diameter.

FIG. 1b is a structural schematic view of a pull mechanism according to the present invention when the pull mechanism is pulled downward after the pull mechanism is sheathed with an upper cover.

FIG. 1c is a schematic view of a pull mechanism according to the present invention, with a pull rope wound around a rotary disc with a larger diameter.

FIG. 1d is a structural schematic view of a pull mechanism according to the present invention when the pull mechanism is pulled upward after the pull mechanism is sheathed with an upper cover.

FIG. 2 is a sectional structural schematic view of an embodiment of a pull type transmission system according to the present invention. In the figure, the pull rope is in a tightened state and wound around a rotary disc with a smaller diameter.

FIG. 3 is a sectional structural schematic view of an alternative embodiment of a pull type transmission system according to the present invention. In the figure, the pull rope is in a tightened state and wound around a rotary disc with a larger diameter.

FIG. 4a is a structural three-dimensional schematic view of a pull mechanism according to the present invention, with the pull rope not connected.

FIG. 4b is a structural three-dimensional schematic view of a pull mechanism according to the present invention, with the pull rope not connected.

FIG. 4c is an A-A sectional structural schematic view in FIG. 4b.

FIG. 5 is an exploded structural schematic view of a pull type transmission system according to the present invention as a food processor, with the food processing device not connected.

FIG. 6 is an exterior structural three-dimensional schematic view of a food processor according to the present invention.

FIG. 7 is a structural schematic view of a guide groove provided for the upper cover according to the present invention.

FIG. 8a is a front structural schematic view of the first embodiment of a guide mechanism according to the present invention.

FIG. 8b is a three-dimensional structural schematic view of the first embodiment of a guide mechanism according to the present invention.

FIG. 8c is a left structural schematic view of FIG. 8a.

FIG. 9 is a three-dimensional structural schematic view of the second embodiment of a guide mechanism according to the present invention.

FIG. 10a is a front structural schematic view of the third embodiment of a guide mechanism according to the present invention.

FIG. 10b is a three-dimensional structural schematic view of the third embodiment of a guide mechanism according to the present invention.

FIG. 10c is a left structural schematic view of FIG. 10a.

FIG. 11a is a front structural schematic view of the fourth embodiment of a guide mechanism according to the present invention.

FIG. 11b is a three-dimensional structural schematic view of the fourth embodiment of a guide mechanism according to the present invention.

FIG. 11c is a left structural schematic view of FIG. 10a.

FIG. 11d is a three-dimensional structural schematic view of another pattern of the fourth embodiment of a guide mechanism according to the present invention.

FIG. 12a is a front structural schematic view of a pull type transmission system according to the present invention, which is used on the upper side of the food processor.

FIG. 12b is a three-dimensional structural schematic view of a pull type transmission system according to the present invention, which is used on the upper side of the food processor.

FIG. 12c is a left structural schematic view of FIG. 12a.

### DETAILED DESCRIPTION

The present invention discloses a pull type transmission system, which comprises a pull mechanism 1, the pull mechanism 1 at least comprises a coaxial column, the coaxial column is formed by connecting rotary discs 11 with different diameters, and planes connecting the rotary discs 11 with different diameters are connecting faces 12.

The pull mechanism 1 is provided with a rope tying position 2, the rope tying position 2 is arranged on a side face of the pull mechanism 1, and the pull rope 3 is connected to the pull mechanism 1 through the rope tying position 2 at one end and is wound around the rotary discs 11; and the pull mechanism is connected to a resilience mechanism 4 providing a resilience force and is used for retracting the pull rope 3 after the pull rope 3 is pulled out.

The resilience mechanism here generally can be a coil spring (tension spring) and is arranged above or below the pull mechanism (in this embodiment, the resilience mechanism is below the pull mechanism). The resilience mechanism is a common existing structure. In the present invention, in the initial state the pull rope is wound around the rotary discs and the coil spring is in a slack state; after the pull rope is pulled out, the coaxial column rotates, and the coil spring becomes in a tightened state; after the pull rope is released, the coil spring resumes a slack state due to the effect of its own elastic force, in other words, the pull rope is provided with a resilience force to drive the rotary discs to rotate and re-wind the pull rope around the rotary discs. Due to the different diameters of the rotary discs, the pull rope can be pulled diagonally upward or downward during use. When the pull rope rebounds after being pulled out, the pull rope can be freely wound around the rotary discs with different diameters. When the pull rope is pulled again, because the distance between the pull rope and the axis is different, different torques can be generated, which leads to different twisting forces and speeds under different rotation modes.

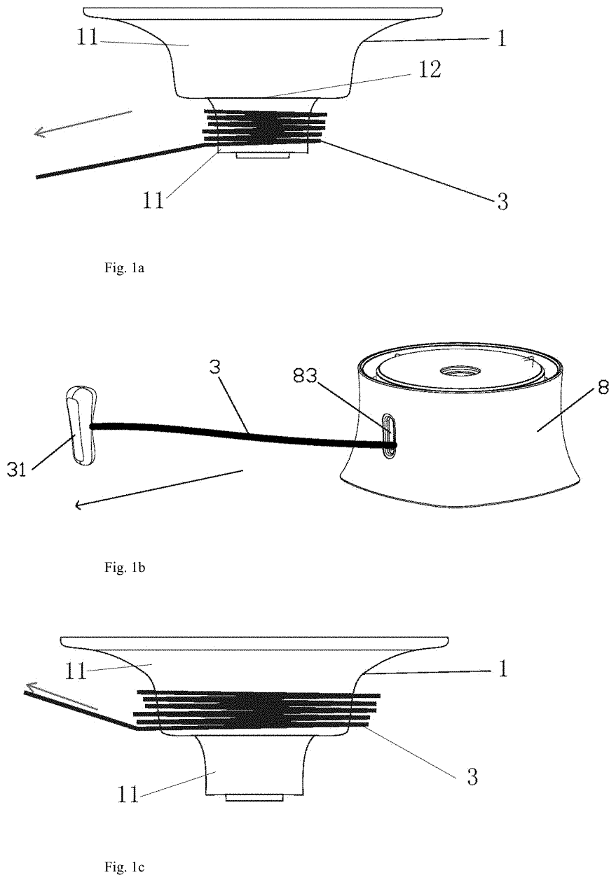

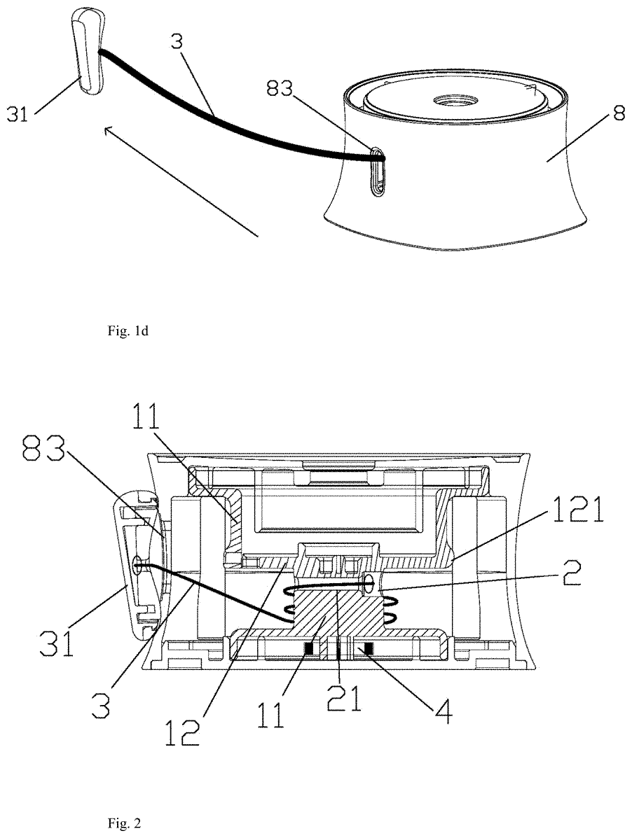

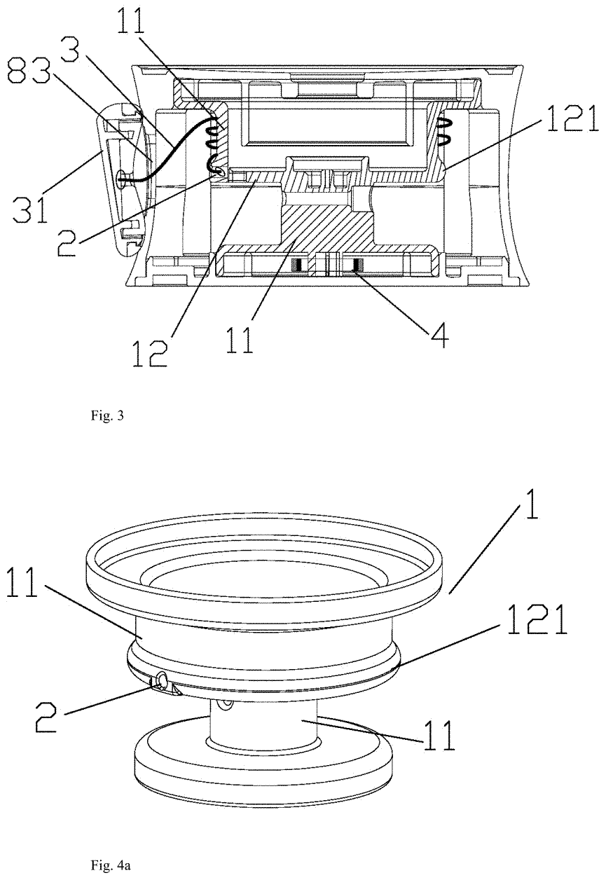

In a preferred embodiment, the coaxial column is formed by connecting two rotary discs 11 with different diameters, as shown in FIG. 1a and FIG. 1c, where the upper rotary disc 11 has a larger diameter and the lower rotary disc 11 has a smaller diameter. The upper rotary disc with a larger diameter can output a greater power, and the lower rotary disc with a smaller diameter can output a higher speed. Alternatively, the upper rotary disc can have a smaller diameter and the lower rotary disc can have a larger diameter. Considering ergonomics, the downward/horizontal pulling action is more suitable for high-speed rotation, so it is preferred that the lower rotary disc has a smaller diameter and the upper rotary disc has a larger diameter. As shown in FIG. 1a and FIG. 1b, when being pulled downward, the pull rope is fixed on the rotary disc with a smaller diameter and brings out a higher-speed rotation output. As shown in FIG. 1c and FIG. 1d, when being pulled upward, the pull rope is fixed on the rotary disc with a larger diameter and brings out a larger-torque rotation output.

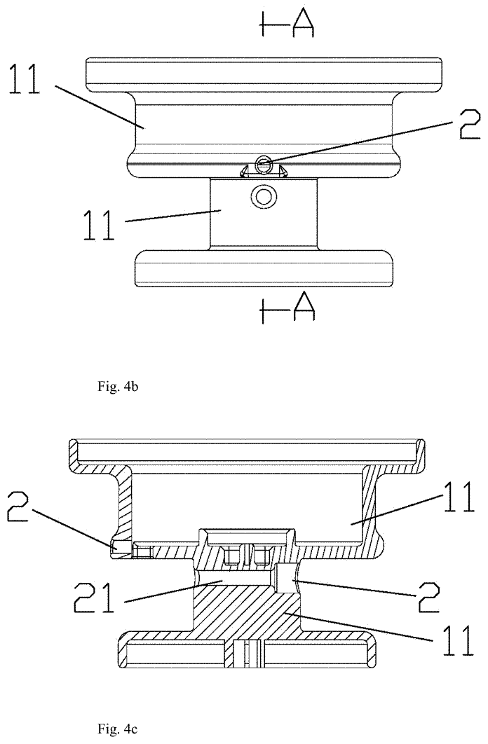

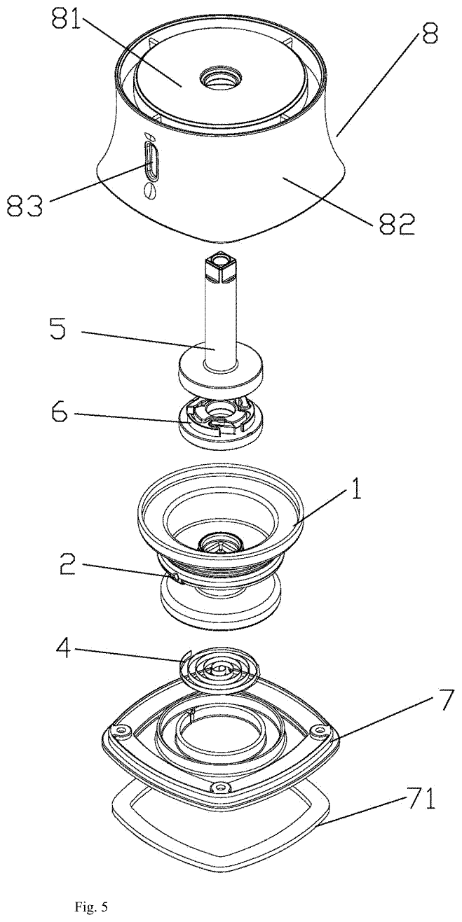

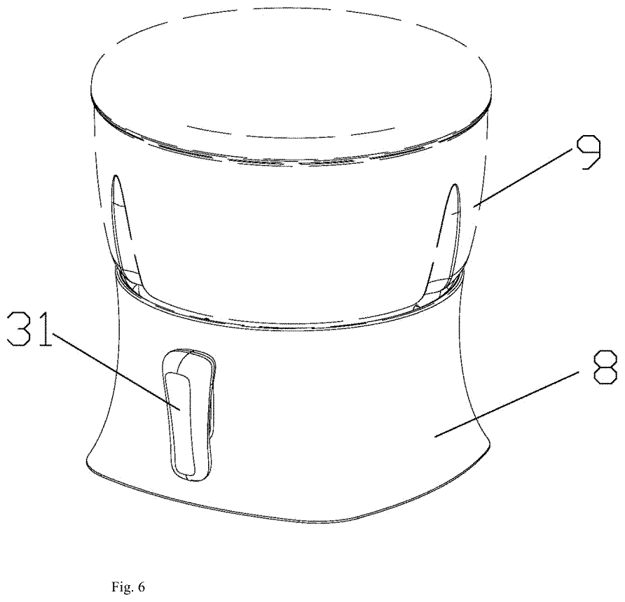

The rope tying position 2 may be arranged adjacent to the connecting face 12. As shown in FIG. 2, the rope typing position is arranged on the lower rotary disc 11 and adjacent to the connecting face. Of course, the rope typing position may also be arranged on the upper rotary disc and adjacent to the connecting face. Further, as shown in FIG. 2, FIG. 3 and FIG. 4a to FIG. 4c, the connecting face 12 may also extend outward and be provided with flange 121 slightly protruding outward. As shown in FIG. 2 and FIG. 4a to FIG. 4c, the rope tying position 2 may be arranged on the flange 121. These structures all can achieve upward or downward pull of the pull rope, so that the pull rope 3 is wound around the corresponding rotary disc, and the slightly protruding structure of the flange can help tighten the pull rope when the pull rope is retracted, and can also help the pull rope to shuttle smoothly through parts of different diameters. FIG. 4a to FIG. 4c show two different rope tying positions, and the pull rope can be fixed to the corresponding rope tying position according to requirements.

As shown in FIG. 2, in order to better retract the pull rope 3, the rope tying position 2 can be a structure that runs through the rotary discs 11, and forms a through slot 21 inside the rotary discs 11, and one end of the pull rope 3 is connected to one end of the slot, and the other end of the pull rope passes through the slot 21 and sticks out of the rotary discs 11. In this figure, the pull rope and the rope tying position are both arranged on the lower rotary disc. In addition, the rope tying position 2 can also be arranged inside the rotary discs 11, one end of the pull rope 3 is connected to the rope tying position 2 inside the rotary discs 11, and the other end of the pull rope sticks out of the rotary discs 11.

In actual use, the foregoing pull type transmission system is generally used in a food processor.

The present invention further discloses a food processor. As shown in FIG. 5 and FIG. 6, the food processor comprises the foregoing pull type transmission system, the pull mechanism 1 is connected to a transmission mechanism, and the transmission mechanism is connected to a food processing device that is operated in a rotating manner. The pull mechanism drives the transmission mechanism through rotation, and the transmission mechanism then drives the food processing device. The transmission mechanism can be an ordinary transmission shaft 5. The rotation of the pull mechanism drives the transmission shaft 5 to rotate, thereby further driving the food processing device. In this embodiment, as shown in the figure, it can be a transmission shaft 5 with a one-way gear set 6, and the transmission shaft 5 is connected to a food processing device. When the coil spring drives the pull mechanism to rotate back, the coil spring will not transmit the rotating power to the transmission shaft, so that the transmission shaft continues to rotate according to inertia, without affecting the operation of the food processing device. The food processing device here can be any existing device that achieves the corresponding functions by means of rotation, for example, a chopper, an agitator or a dehydrator, as shown in the figure, which is a schematic structural view of a container with a food processing device. The transmission structure of this transmission shaft, the transmission structure combined with a one-way gear set, and the structure and function of the corresponding food processing device are all prior art structures and products, and can be implemented by those of ordinary skill in the art.

The food processor according to the present invention is further provided with a bottom cover 7, a non-slip mat 71 can be arranged under the bottom cover, and the center of the bottom cover 7 is connected to a resistance mechanism 4. Here, the resistance mechanism 4 is a tension spring (coil spring), and the bottom cover 7 is connected to the pull mechanism 1. The pull mechanism 1 is sheathed with an upper cover 8 that covers the pull mechanism 1. The upper cover 8 comprises a top surface 81 at the top and a side wall 82 on the side face. The upper part of the transmission shaft 5 passes through the top surface 81 of the upper cover and is connected to the food processing device. The lower edge of the wall 82 is connected to the bottom cover 7, and the side wall 82 of the upper cover 8 is provided with a guide groove 83 allowing the tying rope to pass through, as shown in FIG. 7. The guide groove 83 is arranged at same level with the rope tying position 2 (as shown in FIG. 2 and FIG. 3). The guide groove 83 is a longitudinal guide groove, and the length of the guide groove 83 spans the rotary discs 11 with different diameters. Accordingly, the outer end of the pull rope 3 is connected to a handle 31, and the length of the handle 31 is greater than the length of the longitudinal guide groove 83. As shown in FIG. 1b and FIG. 1d, the handle 31 can be used to pull the pull rope more conveniently and comfortably, the guide groove 83 may also play a role in limiting the pull rope, and the handle 31 can be stuck on the outside of the guide groove 83 after the pull rope 3 rebounds.

As shown in FIG. 6, which is an exterior structural schematic view of a food processor according to the present invention, the upper cover contains a pull type transmission system, and the food processing device is connected above the upper cover. The structure internally has a blade and a stirring tool in general and externally is a transparent or opaque outer cover 9.

Further, the pull type transmission system according to the present invention may also be additionally provided with a guide structure. The purpose of the guide structure is to pull the pull rope, so as to guide the pulling direction and horizontal height of the pull rope and more accurately and conveniently wind the pull rope around the rotary discs with different diameters. The guide structure comprises a limit component 20 allowing the pull rope to pass through and limiting the pull rope, and a control module 21 controlling the up and down movement of the limit component 20, the pull rope 3 passes through the limit component 20 and the position of the limit component 20 is controlled by the control module 21, thereby controlling the position of the pull rope 3.

Ordinary simple mechanical structures all can achieve this function. Several specific embodiments are given below.

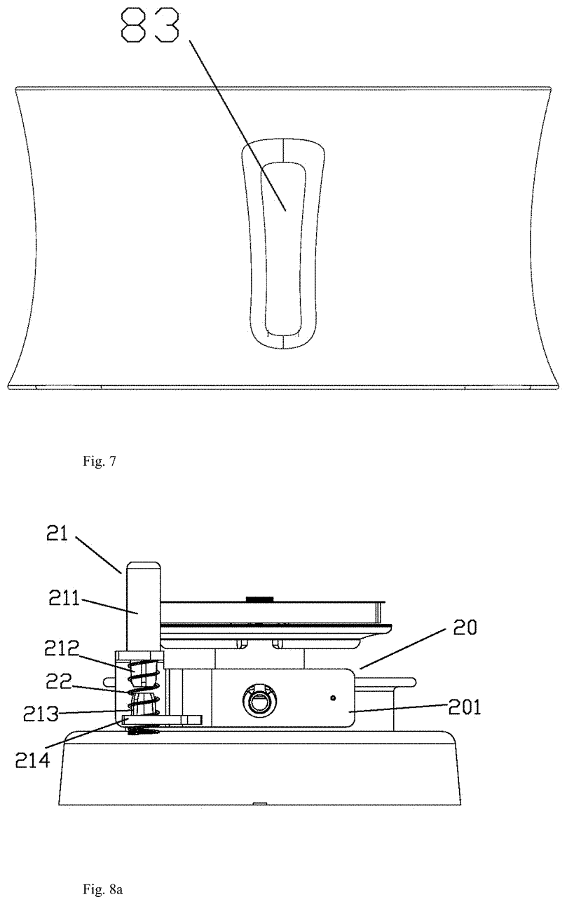

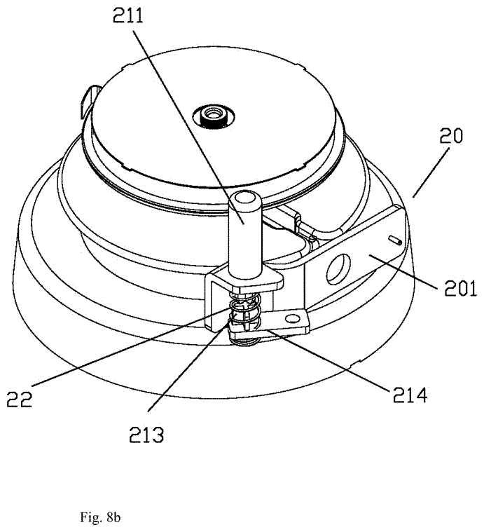

FIG. 8a to FIG. 8c show a button-type spring reset solution. The control module 21 comprises a button shaft 211, below the button shaft 211 is a second shaft 212, the diameter of the second shaft 212 is smaller than the diameter of the button shaft 211, a third shaft 213 is provided at a certain distance below the second shaft 212, and the third shaft 213 and the second shaft 212 have the same diameter. The shafts here can be cylinders, cross-shaped columns, or columns in other shapes. The second shaft 212 and the third shaft 213 are sheathed with a spring 22; a platform 214 is connected below the third shaft 213, and the lower end of the spring 22 presses against the platform 214; the limit component 20 is a laterally arranged perforated sheet body 201, one side of the perforated sheet body 201 is connected to the button shaft 211, and the pull rope 3 passes through a hole of the perforated sheet body. When the button shaft is pressed and moves up and down during use, the perforated sheet body is driven to move up and down. Since the pull rope has passed through a perforated sheet, the pull rope can move up and down with the limit component, so that the pull rope can be wound around the rotary discs with different diameters more accurately and conveniently, while the spring has a reset effect, and rebounds and resets when the button shaft is released.

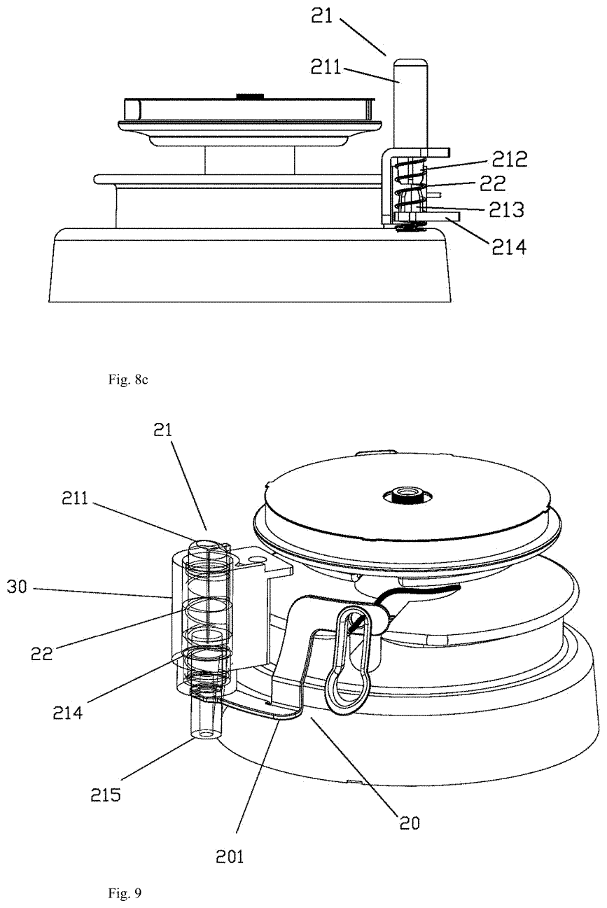

Similar to the structures shown in FIG. 8a to FIG. 8c, FIG. 9 also shows a button-type spring reset solution. The control module 21 comprises a button shaft 211, the button shaft 211 is coaxially sheathed with a conduit slot 30, a thin shaft 215 is connected below the button shaft 211, the thin shaft 215 is sheathed with a spring 22, the top of the spring 22 presses against the bottom of the button shaft 215, and the bottom of the spring presses against a bottom platform 214 on the inner side of the conduit slot 30; the limit component 20 is a laterally arranged perforated sheet body 201, one side of the perforated sheet body 201 is connected to the thin shaft 215, and the pull rope 3 passes through a hole of the perforated sheet body 201. When the button shaft is pressed and moves up and down during use, the perforated sheet body is driven to move up and down. Since the pull rope has passed through a perforated sheet, the pull rope can move up and down with the limit component, so that the pull rope can be wound around the rotary discs with different diameters more accurately and conveniently, while the spring has a reset effect, and rebounds and resets when the button shaft is released. The shape of the perforated sheet here can be set freely according to requirements, or other methods can be used to guide the pull rope, such as a gap, and an open slot.

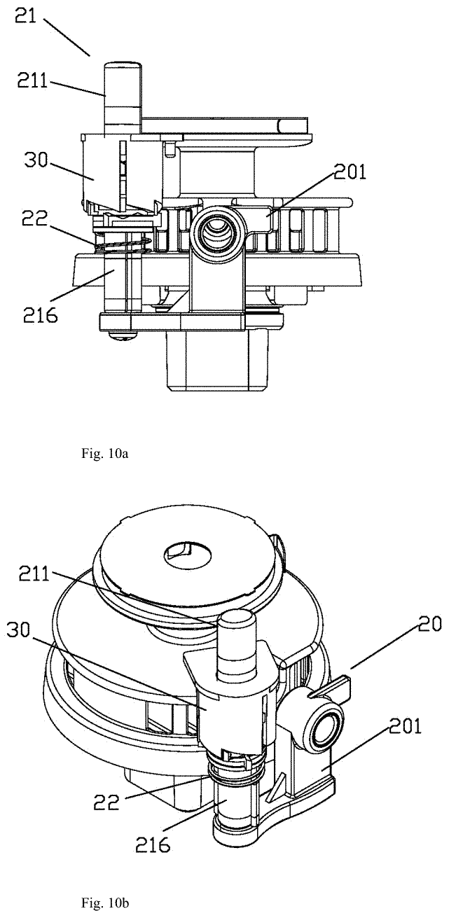

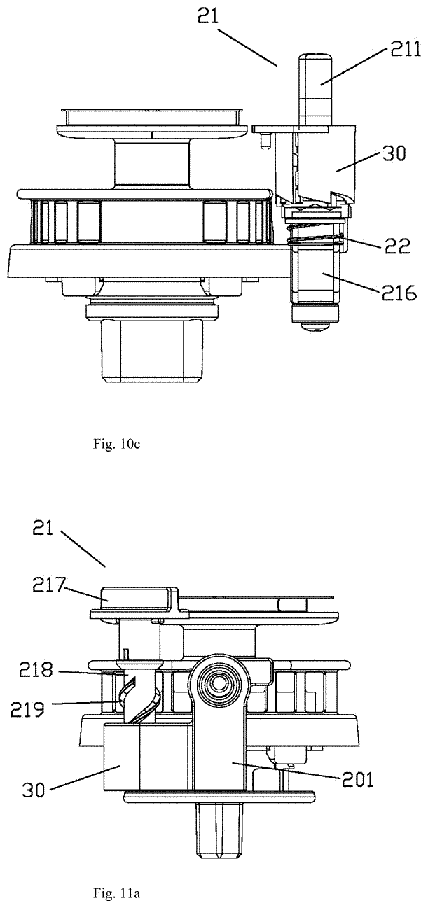

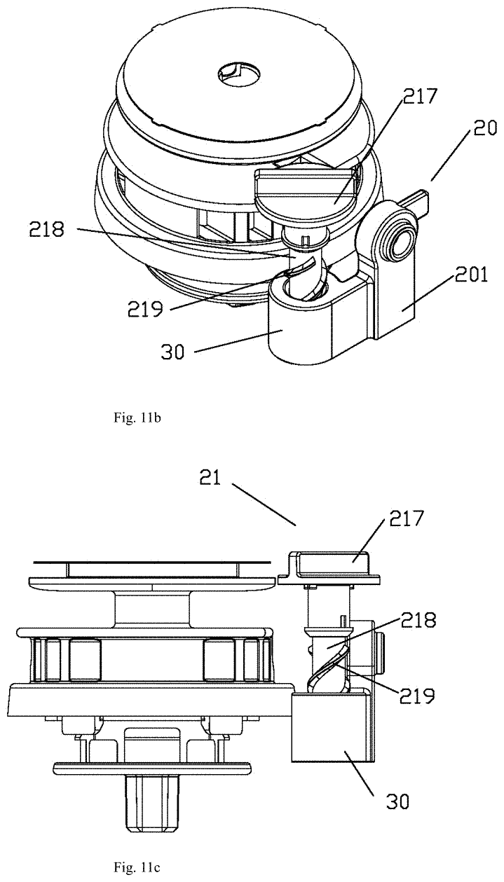

FIG. 10a to FIG. 10c show a button solution with locked shafts. The control module 21 is a button structure of a ball pen, which uses the corresponding structure of the button type ball pen as the structure of the control module. The control module comprises a button shaft 211, the button shaft 211 is coaxially sheathed with a conduit slot 30 with a serrated bottom, the button shaft 211 is sheathed with a spring 22 used for reset, and a movable column 216 that moves up and down is connected below the button shaft through a spring 22; the limit component 20 is a laterally arranged perforated sheet body 201, one side of the perforated sheet body 201 is connected to the movable column 216, and the pull rope 3 passes through a hole of the perforated sheet body 201. In this embodiment, a common locking structure on a ball pen is used as the structure of the control module. It is locked with a single press and unlocked with double press and meanwhile the limit component is driven to move up and down, and the pull rope can move up and down with the limit component, so that the pull rope can be wound around the rotary discs with different diameters more accurately and conveniently.

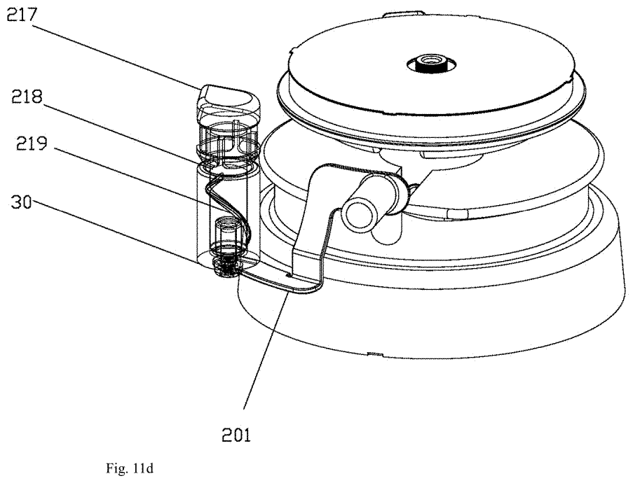

FIG. 11a to FIG. 11c show a button reset solution. The control module 21 comprises a knob shaft 217, above the knob shaft 217 is a knob, a shaft body 218 is connected below the knob, a first guide structure 219 is provided outside the shaft body 218, the shaft body 218 is sheathed with a conduit slot 30, the inner side of the conduit slot 30 is provided with a second guide structure (not shown in the figure) that matches the first guide structure 219, and by relying on the interaction between the first guide structure 219 and the second guide structure, the knob shaft 217 is rotated to drive the conduit slot 30 to move up and down; the guide structure 20 is a laterally arranged perforated sheet body 201, one side of the perforated sheet body 201 is connected to the conduit slot 30, and the pull rope 3 passes through a hole of the perforated sheet body 201. The first guide structure 219 may be a threaded or tapered convex bone or groove, and the second guide structure is a corresponding threaded or tapered groove or convex bone. During use, the knob shaft is rotated, and the conduit slot moves through the matched first guide structure and second guide structure to drive the perforated sheet to move up and down, while the pull rope moves up and down with the limit component, so that the pull rope can be wound around the rotary discs with different diameters more accurately and conveniently. FIG. 11d provides another button reset solution, of which structure is similar to the structures shown in the foregoing FIG. 11a to FIG. 11c, so it is not described again.

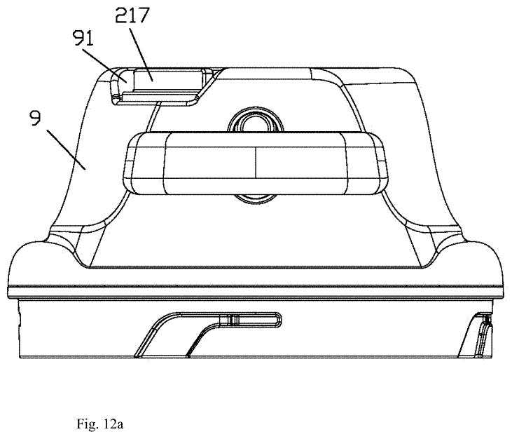

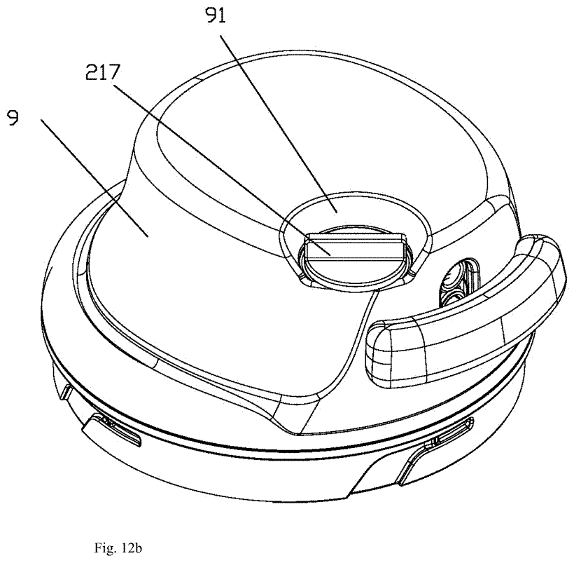

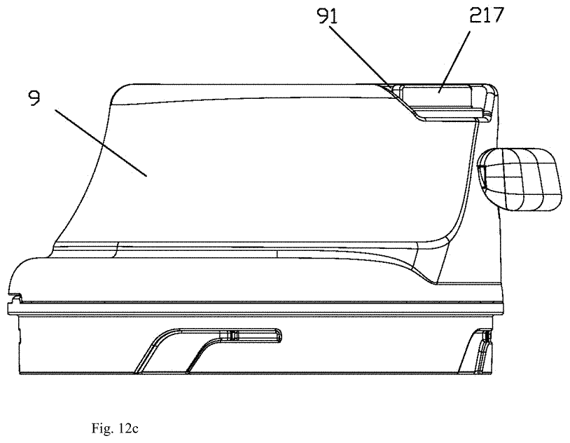

In addition, for the foregoing solutions with a guide structure, when used as a food processor, as shown in FIG. 12a to FIG. 12c, it is preferred to arrange the transmission system on the top of the entire food processor, that is, the food processing device is connected below the transmission shaft, and above the transmission shaft is an outer cover 9, the upper surface of the outer cover 9 is provided with a through hole 91 to expose the guide structure, and the knob of the knob shaft is exposed in this drawing. The transmission system is more hygienic and aesthetic. During use, the top cover can be pressed with one hand and the pull rope can be pulled with the other hand, which is more in line with the requirements of ergonomics.

To sum up, the present invention provides a brand-new non-electric pull type transmission system, which can be used a core structure to make various kinds of food processors. The non-electric pull type gear shifting transmission system has a simple structure. The corresponding rotating gears can be changed through simple up-down pulling actions without having to shut down and replace equipment or interrupt the pulling operation, making the use more convenient.

1. A pull type transmission system, wherein the pull type transmission system comprises a pull mechanism, the pull mechanism at least comprises a coaxial column, the coaxial column is formed by connecting rotary discs with different diameters, and planes connecting the rotary discs with different diameters are connecting faces;
the pull mechanism is provided with a rope tying position, the rope tying position is arranged on a side face of the pull mechanism, and the pull rope is connected to the pull mechanism through the rope tying position at one end and is wound around the rotary discs; and the pull mechanism is connected to a resilience mechanism providing a resilience force and is used for retracting the pull rope after the pull rope is pulled out.

2. The pull type transmission system according to claim 1, wherein the coaxial column is formed by connecting two rotary discs with different diameters.

3. The pull type transmission system according to claim 1, wherein the connecting faces extend outward and is provided with flange protruding outward.

4. The pull type transmission system according to claim 1, wherein the rope tying position is adjacent to the connecting faces and located above or below the connecting faces.

5. The pull type transmission system according to claim 4, wherein the rope tying position is a structure that runs through the rotary discs, and the pull rope extends outward from the rotary discs.

6. The pull type transmission system according to claim 1, wherein the resilience mechanism is a set of coil springs and arranged above or below the pull mechanism.

7. The pull type transmission system according to claim 1, wherein the transmission system is further provided with a guide structure, the guide structure comprises a limit component allowing the pull rope to pass through and limiting the pull rope, and a control module controlling the up and down movement of the limit component, and the pull rope passes through the limit component and the position of the limit component is controlled by the control module, thereby controlling the position of the pull rope.

8. The pull type transmission system according to claim 7, wherein the control module comprises a button shaft, below the button shaft is a second shaft, the diameter of the second shaft is smaller than the diameter of the button shaft, a third shaft is provided at a certain distance below the second shaft, the third shaft and the second shaft have the same diameter, and the second shaft and the third shaft are sheathed with a spring; a platform is connected below the third shaft, and the lower end of the spring presses against the platform;
the limit component is a laterally arranged perforated sheet body, one side of the perforated sheet body is connected to the button shaft, and the pull rope passes through a hole of the perforated sheet body.

9. The pull type transmission system according to claim 7, wherein the control module comprises a button shaft, the button shaft is coaxially sheathed with a conduit slot, a thin shaft is connected below the button shaft, the thin shaft is sheathed with a spring, the top of the spring presses against the bottom of the button shaft, and the bottom of the spring presses against a bottom platform on the inner side of the conduit slot;
the limit component is a laterally arranged perforated sheet body, one side of the perforated sheet body is connected to the thin shaft, and the pull rope passes through a hole of the perforated sheet body.

10. The pull type transmission system according to claim 7, wherein the control module is a button structure of a ball pen, and comprises a button shaft, the button shaft is coaxially sheathed with a conduit slot with a serrated bottom, the button shaft is sheathed with a spring used for reset, and a movable column that moves up and down is connected below the button shaft through a spring;
the limit component is a laterally arranged perforated sheet body, one side of the perforated sheet body is connected to the movable column, and the pull rope passes through a hole of the perforated sheet body.

11. The pull type transmission system according to claim 7, wherein the control module comprises a knob shaft, above the knob shaft is a knob, a shaft body is connected below the knob, a first guide structure is provided outside the shaft body, the shaft body is sheathed with a conduit slot, the inner side of the conduit slot is provided with a second guide structure that matches the first guide structure, and by relying on the interaction between the first guide structure and the second guide structure, the knob shaft is rotated to drive the conduit slot to move up and down;
the limit component is a laterally arranged perforated sheet body, one side of the perforated sheet body is connected to the conduit slot, and the pull rope passes through a hole of the perforated sheet body.

12. The pull type transmission system according to claim 11, wherein the first guide structure is a threaded or tapered convex bone or groove, and the second guide structure is a threaded or tapered groove or convex bone.

13. A food processor, wherein the food processor comprises a pull type transmission system as described in claim 1, the pull mechanism is connected to a transmission mechanism, and the transmission mechanism is connected to a food processing device that is operated in a rotating manner.

14. The food processor according to claim 13, wherein the food processor is further provided with a bottom cover, the center of the bottom cover is connected to a resilience mechanism, the bottom cover is connected to the pull mechanism, the pull mechanism is sheathed with an upper cover that covers the pull mechanism, the upper cover comprises a top surface at the top and a side wall on the side face, the bottom edge of the side wall is connected to the bottom cover, and the side wall of the upper cover is provided with a guide groove allowing the pull rope to pass through.

15. The food processor according to claim 14, wherein the guide groove is arranged at same level with the rope tying position, the guide groove is a longitudinal guide groove, and the length of the guide groove spans the rotary discs with different diameters; the outer end of the pull rope is connected to a handle, and the length of the handle is greater than the length of the longitudinal guide groove.

16. The food processor according to claim 13, wherein the transmission mechanism is a rotating shaft or a transmission shaft connected to a one-way gear, and the upper part of the transmission shaft passes through the top surface of the upper cover and is connected to the food processing device.

17. A food processor, wherein the food processor comprises a pull type transmission system as described in claim 7, the pull mechanism is connected to a transmission mechanism, and the transmission mechanism is connected to a food processing device that is operated in a rotating manner; the transmission mechanism is a rotating shaft or a transmission shaft connected to a one-way gear, the food processing device is connected below the transmission shaft, and above the transmission shaft is an outer cover, and the upper plane of the outer cover is provided with a through hole to expose the guide structure.
